(19) United States
(12) Patent Application Publication
(10) Pub. No.: US 2002/0023016 A1
(43) Pub. Date: Feb. 21, 2002

(54) On-line shopping system using two terminals

(76) Inventor: Hiroshi Tanuma, Tokyo (JP)

Correspondence Address: McGuire Woods, 1750 Tysons Boulevard, Suite 1800, Tysons Corner, McLean, VA, 22102-4215, US

(21) Appl. No.: 09/840,086

(22) Filed: Apr. 24, 2001

(30) Foreign Application Priority Data
Apr. 27, 2000 (JP) 2000-128204

(51) Int. Cl. G06F 17/60

(52) U.S. Cl. 705/26

(57) ABSTRACT

In an on-line shopping system including a commerce provider server connected to a network, a user terminal is provided at a user's home and is connected to the network to receive goods information from the commerce provider server and transmit selected goods information and an identification number of the user to the commerce provider server. A multimedia terminal is provided at a store and is connected to the network to transmit the identification number to the commerce provider server and receive the selected goods information from the commerce provider server to acknowledge the selected goods information.

### BACKGROUND OF THE INVENTION

1. Field of the Invention

The present invention relates to an on-line shopping system.

2. Description of the Related Art

In a first prior art on-line shopping system including a commerce provider server connected to a network, a user terminal is provided at a user's home and is connected to the network. The user terminal receives goods information from the commerce provider server and transmits selected goods information and an identification number (ID) of the user to the commerce provider server. Then, the user terminal carries out a settlement by Internet debit money, credit card information or the like. Such a settlement can be carried out by transferring money to the bank account of an on-line shopping company. This will be explained later in detail.

In the above-described first prior art on-line shopping system, however, if the settlement is carried out by transferring money to the bank account, the reliability is low and also, the burden of the user is increased. Further, if the user specifies the date and time of delivery of the selected goods, the user has to be at home at this specified date and time, which also increases the burden of the user.

In a second prior art on-line shopping system, a multimedia terminal is provided instead of the user terminal of the first prior art on-line system. The multimedia terminal is installed in a store such as a convenience store which may be open around the clock, and therefore, the user can easily access the multimedia terminal. In this case, the multimedia terminal is always expected to be logged in to the Internet commerce provider server. Therefore, the goods information is displayed on a display unit of the multimedia terminal. Therefore, the user reads the goods information provided by the on-line shopping company, so that the user selects one of the goods information. Then, the user transmits the selected goods information along with his or her pre-allocated ID number to the Internet commerce provider server. Next, the user carries out a settlement at the convenience store. Finally, the selected goods are delivered by a delivery company to the convenience store. Thus, the user can get the selected goods at the convenience store whenever he or she wants to after one day or so passes. This also will be explained later in detail.

Thus, in the above-described second prior art on-line shopping system, since the settlement is carried out at the convenience store by cash or the like, the reliability is high and also, the burden of the user is decreased. Further, the user need not be at home at a specified date and time, which also decreases the burden of the user.

In the above-described second prior art on-line shopping system, however, if the user takes a lone time to select the goods information, such a long time may create a serious problem, since other users are affected by the long time, which would decrease the efficiency of the on-line shopping system.

### SUMMARY OF THE INVENTION

It is an object of the present invention to provide an on-line shopping system and method capable of increasing the efficiency thereof.

According to the present invention, in an on-line shopping system including a commerce provider server connected to a network, a user terminal is provided at a user's home and is connected to the network to receive goods information from the commerce provider server and transmit selected goods information and an ID number of the user to the commerce provider server. A multimedia terminal is provided at a store and is connected to the network to transmit the ID number to the commerce provider server and receive the selected goods information from the commerce provider server to acknowledge the selected goods information.

Thus, since the time of the multimedia terminal occupied by the user is shortened, the efficiency of the on-line shopping system is increased.

Also, in an on-line shopping method, a user terminal provided at a user's home is connected via a network to a commerce provider server. Then, goods information is transmitted from the commerce provider server via the network to the user terminal. Then, selected goods information and an ID number from the user terminal is transmitted via the network to the commerce provider. Then, the ID number is transmitted from a multimedia terminal provided at a store to the commerce provider server. Finally, the selected goods information in correspondence with the ID number is transmitted from the commerce provider server via the network to the multimedia terminal.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating a first prior art on-line shopping system;

FIG. 2 is a timing diagram showing an operation of the on-line shopping system of FIG. 1;

FIG. 3 is a block circuit diagram illustrating a second prior art on-line shopping system;

FIG. 4 is a timing diagram showing an operation of the on-line shopping system of FIG. 3;

FIG. 5 is a block circuit diagram illustrating an embodiment of the on-line shopping system according to the present invention; and

FIGS. 6 and 7 are timing diagrams showing operations of the on-line shopping system of FIG. 5.

### DESCRIPTION OF THE PREFERRED EMBODIMENT

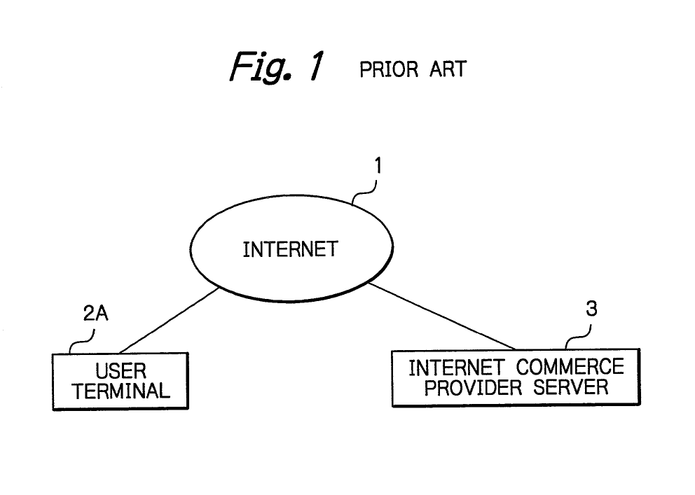

Before the description of the preferred embodiment, prior art on-line shopping systems will be explained with reference to FIGS. 1, 2, 3 and 4.

In FIG. 1, which illustrates a first prior art on-line shopping system, reference numeral 1 designates the Internet. Also, a user terminal 2A such as a personal computer installed at a consumer's home is connected via an Internet service provider (not shown) to the Internet 1, and an Internet commerce provider server 3 is connected to the Internet 1.

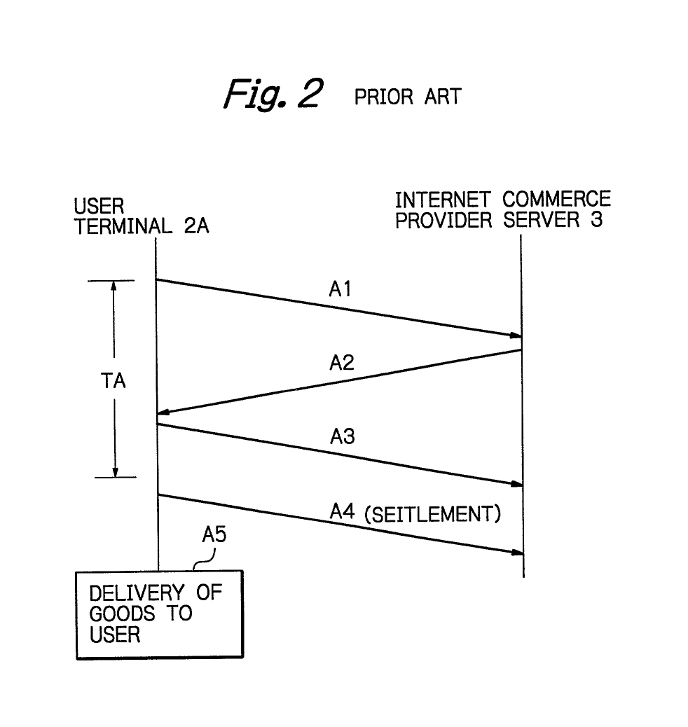

The operation of the on-line shopping system of FIG. 1 is explained next with reference to FIG. 2.

First, as indicated by A1, when the user inputs a special telephone number into the user terminal 1, the user terminal 2A is connected via the Internet 1 to the Internet commerce provider server 3. Thus, the user terminal 2A is logged in to the Internet commerce provider server 3.

Next, as indicated by A2, the Internet commerce provider server 3 distributes goods information provided by an on-line shopping company to the user terminal 2A. As a result, the goods information is displayed on a display unit of the user terminal 2A.

Next, the user reads the goods information provided by the on-line shopping company, so that the user selects one of the goods information. For example, if the goods information includes ticket information, the user specifies a date, a grade and the number of tickets. Then, as indicated by A3, the user transmits the selected goods information along with his or her pre-allocated ID number to the Internet commerce provider server 3.

Next, as indicated by A4, the user carries out a settlement by Internet debit money, credit card information or the like. Such a settlement can be carried out by transferring money to the bank account of the on-line shopping company.

Finally, as indicated by A5, the selected goods are delivered by a delivery company to the user. Note that, if the selected goods are small in size, the selected goods can be delivered by mail to the user.

In the on-line shopping system of FIG. 1, however, if the settlement is carried out by transferring money to the bank account, the reliability is low and also, the burden of the user is increased. Further, if the user specifies the date and time of delivery of the selected goods, the user has to be at home at this specified data and time, which also increases the burden of the user.

In the on-line shopping system of FIG. 1, even if the user takes a long time to select the goods information, so as to increase a time period TA as shown in FIG. 2, such a long time period TA may not create a problem, since only the user is affected by the long time period TA.

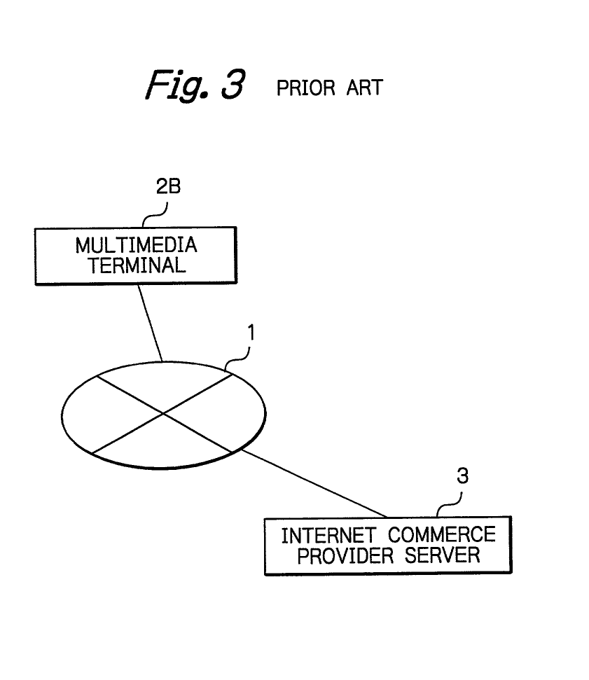

In FIG. 3, which illustrates a second prior art on-line shopping system, a multimedia terminal 2B is provided instead of the user terminal 2A of FIG. 1. The multimedia terminal 2B is installed in a store such as a convenience store. Note that convenience stores are generally built at many locations and are open around the clock, and therefore, the user can easily access the multimedia terminal 2B. Also, the multimedia terminal 2B has a higher level performance than the user terminal 2A of FIG. 1.

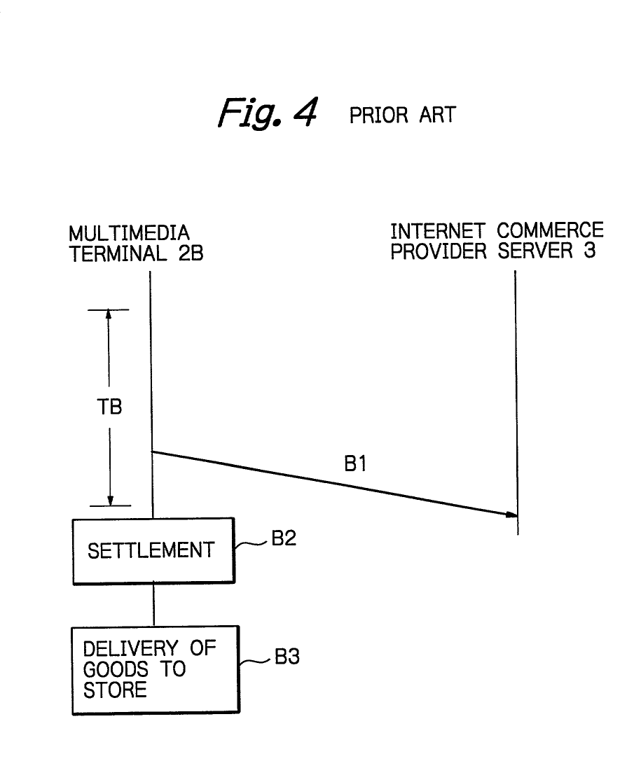

The operation of the on-line shopping system of FIG. 3 is explained next with reference to FIG. 4. In this case, the multimedia terminal 2B is always expected to be logged in to the Internet commerce provider server 3. Therefore, the goods information is displayed on a display unit of the multimedia terminal 2B.

First, the user reads the goods information provided by the on-line shopping company, so that the user selects one of the goods information. For example, if the goods information includes ticket information, the user specifies a date, a grade and the number of tickets. Then, as indicated by B1, the user transmits the selected goods information along with his or her pre-allocated ID number to the Internet Commerce provider server 3.

Next, as indicated by B2, the user carries out a settlement at the convenience store.

Finally, as indicated by B3, the selected goods are delivered by a delivery company to the convenience store. Thus, the user can get the selected goods at the convenience store wherever he or she wants to after one day or so passes. Note that, if the selected goods are small in size, the selected goods can be delivered by mail to the user.

Thus, in the on-line shopping system of FIG. 3, since the settlement is carried out at the convenience store by cash or the like, the reliability is high and also, the burden of the user is decreased. Further, the user need not be at home at a specified date and time, which also decreases the burden of the user.

In the on-line shopping system of FIG. 3, however, if the user takes a long time to select the goods information, so as to increase a time period TB as shown in FIG. 4, such a long time period TB may create a serious problem, since other users are affected by the long time period TB, which would decrease the efficiency of the on-line shopping system.

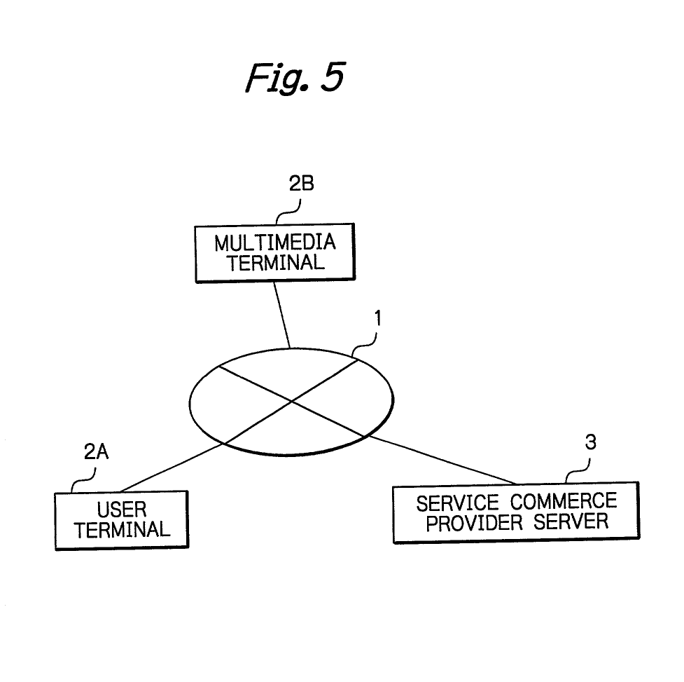

In FIG. 5, which illustrates an embodiment of the on-line shopping system according to the present invention, the user terminal 2A of FIG. 1 and the multimedia terminal 2B of FIG. 3 are both provided.

The operation of the on-line shopping system of FIG. 5 is explained next with reference to FIG. 5.

First, as indicated by A1, when the user inputs a special telephone number into the user terminal 1, the user terminal 2A is connected via the Internet 1 to the Internet commerce provider server 3. Thus, the user terminal 2A is logged in to the Internet commerce provider server 3.

Next, as indicated by A2, the Internet commerce provider server 3 distributes goods information provided by an on-line shopping company to the user terminal 2A. As a result, the goods information is displayed on a display unit of the user terminal 2A.

Next, the user reads the goods information provided by the on-line shopping company, so that the user selects one of the goods information. For example, if the goods information includes ticket information, the user specifies a date, a grade and the number of tickets. Then, as indicated by A3, the user transmits the selected goods information along with his or her pre-allocated ID number to the Internet commerce provider server 3.

Note that the Internet commerce provider server 3 has a storing unit for storing selected goods information in correspondence with ID numbers.

Then, the user moves to the multimedia terminal 2B.

In this case, the multimedia terminal 2B is always expected to be logged in to the Internet commerce provider server 3.

Next, as indicated by B1′, the user inputs the ID number in the multimedia terminal 2B, so that the ID number is transferred to the Internet Commerce provider server 3.

Next, as indicated by B2′, the Internet commerce provider 3 returns the selected goods information in correspondence with the ID number to the multimedia terminal 2B in accordance with the transferred ID number. As a result, the selected goods information as indicated by A3 is displayed on a display unit of the multimedia terminal 2B, so that the user acknowledges the selected goods information.

Next, as indicated by B3′, the user carries out a settlement at the convenience store.

Finally, as indicated by B4′, the selected goods are delivered by a delivery company to the convenience store. Thus, the user can get the selected goods at the store wherever he or she wants to after one day or so passes. Note that, if the selected goods are small in size, the selected goods can be delivered by mail to the user.

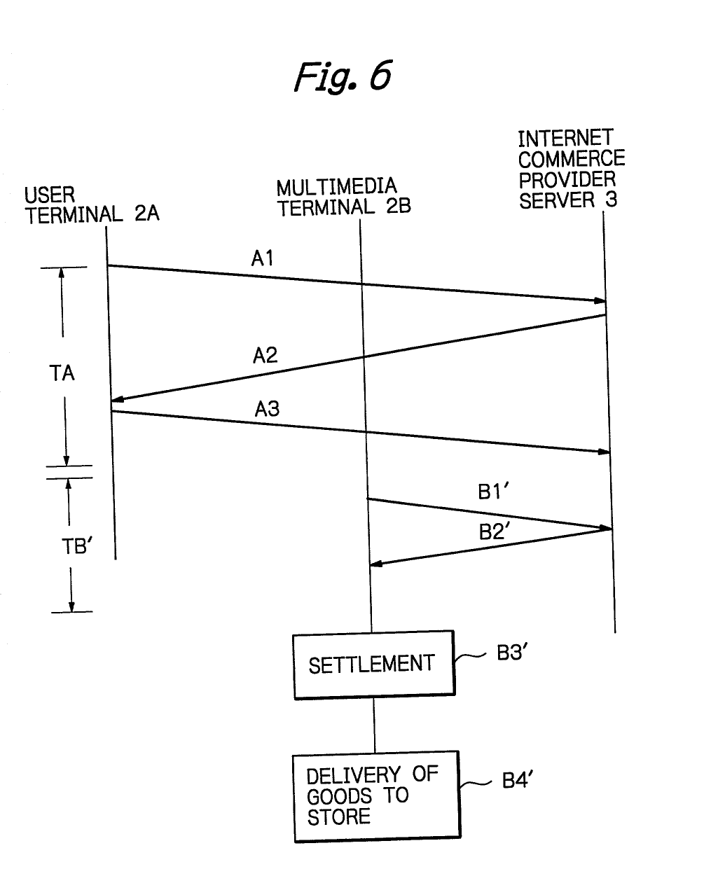

Thus, in the on-line shopping system of FIG. 5, even if the user takes a long time to select the goods information, so as to increase a time period TA as shown in FIG. 6, such a long time period TA may create no problem, since only the user is affected by the long time period TA. On the other hand, since the user takes a very short time TB' at the convenience store, as shown in FIG. 6, other users are not affected, which would increase the efficiency of the on-line shopping system.

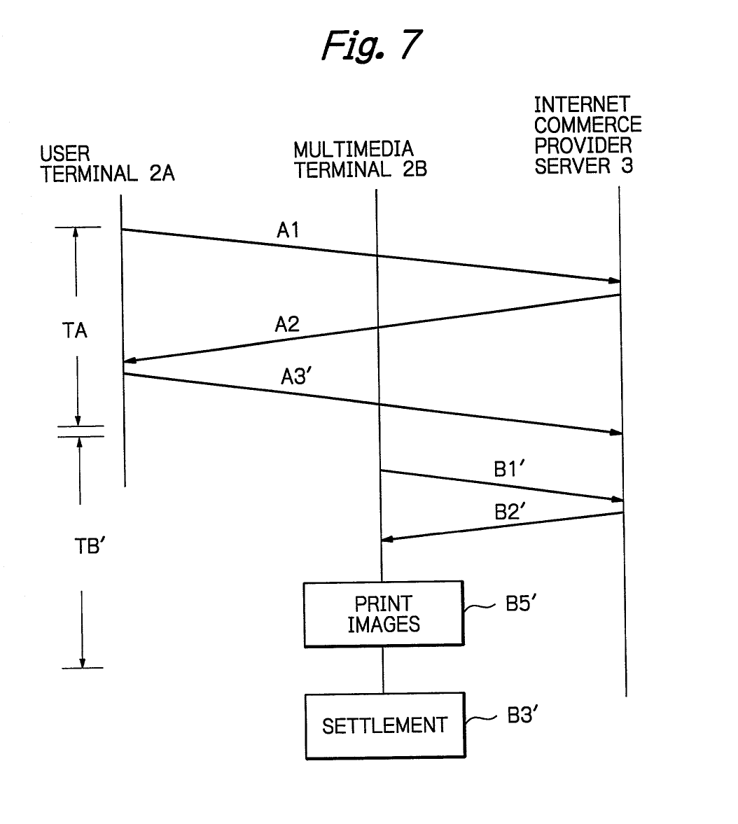

In FIG. 7, which is a timing diagram showing a modification of the timing diagram of FIG. 6, if the user wants the combination of images provided by the Internet commerce provider server 3, as indicated by A3′, the user carries out a combining operation of images at the user terminal 2A, and then, the transmits the combined images to the Internet commerce provider server 3. Note that the Internet commerce provider server 3 has a storing unit for storing combined images in correspondence with ID numbers.

Next, after the user acknowledges the selected good information as indicated by B2′, the user prints the combined images by a printer of the multimedia terminal 2B. Note that the printing performance of the multimedia terminal 2B is higher than that of the user terminal 2A. Thus, the user can accept the high printing performance without special storing medium.

As explained hereinabove, according to the present invention, since a time occupied by the user in a multimedia terminal at a store is shortened, the efficiency of the on-line shopping system can be increased.

1. An on-line shopping system comprising:
a commerce provider server connected to a network;
a first terminal, provided at a user's home and connected to said network, for receiving goods information from said commerce provider server and transmitting selected goods information and an identification number of said user to said commerce provider server; and
a second terminal, provided at a store and connected to said network, for transmitting said identification number to said commerce provider server and receiving said selected goods information from said commerce provider server to acknowledge said selected goods information.

2. The system as set forth in claim 1, wherein said commerce provider server comprises a storing unit for storing selected goods information in correspondence with identification numbers.

3. The system as set forth in claim 1, wherein said network comprises the Internet.

4. The system as set forth in claim 1, wherein said first terminal carries out a combination of information and transmits combined information along with said identification number to said commerce provider server,
said commerce provider server storing said combined information in correspondence with said identification number,
said second terminal receiving said combined information from said commerce provider server in correspondence with said identification number.

5. The system as set forth in claim 4, wherein said second terminal prints said combined information.

6. An on-line shopping method comprising the steps of:
connecting a first terminal provided at a user's home via a network to a commerce provider server;
transmitting goods information from said commerce provider server via said network to said first terminal;
transmitting selected goods information and an identification number from said first terminal via said network to said commerce provider server;
transmitting said identification number from a second terminal provided at a store to said commerce provider server; and
transmitting said selected goods information in correspondence with said identification number from said commerce provider server via said network to said second terminal.

7. The method as set forth in claim 6, wherein said network comprises the Internet.

8. An on-line shopping method comprising the steps of:
connecting a first terminal provided at a user's home via a network to a commerce provider server;
carrying out a combination of information at said first terminal;
transmitting combined information and an identification number from said first terminal via said network to said commerce provider server;
transmitting said identification number from a second terminal provided at a store to said commerce provider server; and
transmitting said combined information in correspondence with said identification number from said commerce provider server via said network to said second terminal.

9. The method as set forth in claim 8, wherein said network comprises the Internet.
